(19) United States
(12) Patent Application Publication
(10) Pub. No.: US 2026/0046732 A1
(43) Pub. Date: Feb. 12, 2026

(54) DEEP REINFORCEMENT LEARNING (DRL)-BASED MOBILITY OPTIMIZATIONS

(71) Applicant: Telefonaktiebolaget LM Ericsson (publ), Stockholm (SE)

(72) Inventors: Yao WEI, Kanata, Ontario (CA); Chung-Horng LUNG, Kanata, Ontario (CA); Samuel Adesoye AJILA, Ottawa, Ontario (CA); Ricardo PAREDES CABRERA, Ottawa, Ontario (CA)

(73) Assignee: Telefonaktiebolaget LM Ericsson (publ), Stockholm (SE)

(21) Appl. No.: 19/101,254

(22) PCT Filed: Sep. 6, 2023
(86) PCT No.: PCT/IB2023/058832

§ 371 Date: Feb. 5, 2025

Related U.S. Application Data
(60) Provisional application No. 63/403,983, filed on Sep. 6, 2022.

(51) Int. Cl. H04W 36/30; H04L 41/16

(52) U.S. Cl. CPC H04W 36/304; H04L 41/16

(57) ABSTRACT

A method, system and apparatus are disclosed. In at least one embodiment, a serving node is configured to communicate with a target node and a wireless device. The serving node is configured to cause transmission of wireless device data to the target node for storage in a buffer of the target node. The serving node is configured to cause, after transmission of the data, handover of the wireless device to the target node.

### FIELD

The present disclosure relates to wireless communications, and in particular, to handover procedures.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Handover and Conditional Handover

Handover is an important function of mobility management in cellular networks. In cellular networks, handover occurs when a wireless device is active on a data session and moves from one network node coverage area to another. Conditional handover (CHO) is specified by 3GPP as a handover improvement mechanism. FIGS. 1A and 1B form a diagram of an example of the 3GPP specified CHO in 5G.

### Machine Learning and Reinforcement Learning

Machine-learning-(ML) powered wireless networks are new trends from network design to infrastructure management and for user performance improvement. The emerging ML-assisted techniques enable a shift from reactive-driven operations to proactive-driven operations for various network applications, including handover management. The target cell selection during the handover is a decision-making problem. The ML-assisted handover management approach ensures that a decision is made for each handover in an efficient and effective manner to increase handover success rate, to and reduce packet loss during the handover process.

The ML algorithms can be classified based on how learning is performed. ML is divided into three main categories: supervised learning, unsupervised learning, and reinforcement learning (RL).
Supervised learning requires a labeled dataset consisting of all the input and output features. It tries to learn a function that maps the inputs to the expected outputs by minimizing the bias and variance errors in the predicted results.
Unsupervised learning has the target of finding the underlying patterns and structures from unlabeled data.
In RL, an agent learns how to map the situations to actions from the feedback and experiences without any labeled or unlabeled input dataset. The agent seeks the optimal action by interacting with the environment, to achieve the maximized reward. FIG. 2 depicts an interaction between agent and environment in RL.

RL is defined as an agent that learns a theoretical optimal action policy by maximizing the accumulated future rewards by interacting with its environment. It is an approach for solving sequential decision-making problems. FIG. 2 demonstrates interaction between an active decision-making agent and its environment in RL. At each time step t of an episode, an agent executes an available action at to interact with the environment in the state s_t. The environment gives the numerical value of reward r_t as the feedback of the action. The state consists of all the necessary information for the agent to make the decision of taking the best choice of action. The action selections are determined on not only the instantaneous rewards, but also the subsequent states, and the future rewards.

### Deep Reinforcement Learning

Deep Reinforcement Learning (DRL) is a combination of RL and deep neural network (DNN). DNN acts as a component of a RL agent in DRL. DRL embraces the advantage of DNN to train the learning process in RL to accelerate the learning process and improve the learning performance in complex decision-making problems. DQN is a value-function-based DRL algorithm, which combines Q-learning with DNN. The DNN acts as a function approximator for the action-value function. DQN is based on training DNN to approximate the optimal action policy and optimal action-value function.

### SUMMARY

Some embodiments advantageously provide methods, systems, and apparatuses for handover procedures.

The present disclosure describes examples of improvements to 3GPP 4G and 5G mobility handover procedures, as well as using ML techniques to improve performance and reliability.
1. Some features of the methods and arrangements disclosed herein may include one or more of the following: 1. Prepare a handover in advance by pre-allocating resources for a wireless device that subscribes to such a service at one or more target cells.
2. The target cell selection is ML-assisted, which is based on the reference signal received quality (RSRQ) conditions in the measurement reports (MR) by the UE (more details later).
3 The pre-allocated resources include a flexible buffer at each target cell. The optimal buffer size is calculated using ML algorithms to reduce packet loss, to reduce packet duplication, and to reduce mobility delays.
4. The number of target cells (0 to n) to pre-allocate resources for a wireless device can be deduced from the Quality-of-Service Class Indicator (QCI). QCI is one of the service-level QoS parameters, each QCI is associated with a priority level defined by 3GPP [1]. The smaller QCI priority level number has higher priority. The wireless device connections with a smaller QCI priority number can have more pre-allocated target cells. For example, QCI priority level 1 could have one or more target cells with pre-allocated resources while QCI priority level 8 may have no target cell to pre-allocate resources, instead, just use standard baseline handover procedures.
5. The flexible buffers at a target cell can be service-based. The number of the buffers (0 to n) can also be deduced from the service QCI. For example, if there are 2 types of service on a wireless device, and the QCI priority values are 4 and 8, respectively. Then the number of the buffers n∈{0, 1, 2}, which means there could be two buffers, one for each service, or only one buffer for higher priority service, or no buffers since the service priority level is higher than a predefined threshold.

Handover management is responsible for handling the mobility of a wireless device in continuing active communication sessions without disruption, ideally during a wireless device's movement. A poorly established parameter configuration excessive handover trigger time and poorly selected target cell selection are possible factors for causing handover failures.

At least one embodiment of a seamless handover technique, namely Pre-connect Handover (PHO), aims to improve handover performance and reliability over known arrangements. Compared with existing 3GPP defined handover procedure(s), the PHO is an enhanced handover management approach.
PHO adopts the Make-Before-Break (MBB) handover scheme, where a wireless device connects to the target cell before being disconnected from the serving cell. The MBB scheme can reduce handover interruption time (HIT) and packet loss during the handover process.
Radio resource pre-allocation: It supports the radio resource pre-allocation on target cell(s) for higher prioritized customer. Target cell prepares the handover in advance by pre-allocating the radio resource and sends a handover command message to wireless device before handover is triggered. The preparation is implemented when radio conditions are stable and reliable, which reduces the chance of handover failure.
The pre-connection between wireless device and target cell is established when radio conditions are stable and reliable, which increases the handover success rate. Pre-connection is implemented in the handover preparation phase, which is earlier than the 3GPP specified conditional handover.
Early data forwarding and buffering. When the pre-connection is established between the wireless device and the candidate target cell, the DL Packet Data Convergence Protocol (PDCP) Service Data Units (SDUs) are forwarded from the serving cell to the preconnected target cell via X2-U interfaces. All the received packets on the target cell are stored in a capacity-adjustable buffer and sent back to the wireless device when the handover procedure is completed. However, before the handover is completed, the data path is between wireless device and the serving cell. The early DL data duplicating-forwarding-buffering mechanism aims to reduce packet loss caused by degraded signal qualities on serving cell and/or radio interference before and during handovers.
The proposed approach provides the ability to establish multiple pre-connections to different target cells, which further increases the handover success rate and provides for better Quality of Service (QoS).
Additionally, PHO utilizes the deep reinforcement learning (DRL) algorithm to facilitate the sequential autonomous decision-making for a mobile wireless device, which may include two key features:
   1. The DRL-based target cell selection is based on wireless-device-measured RSRQ values and the RSRQ change rates.
   2. The DRL-based buffer capacity adjustment is based on the downlink flow rate/throughput and wireless device's moving velocity.
The multi-agent deep reinforcement learning (MADRL)-assisted PHO management solution can also be conducted and effectively applied to a realistic multi-wireless-device environment.
Finally, offline learning and real-time online prediction framework can be used.

According to one aspect of the present disclosure, a serving node configured to communicate with a target node and a wireless device is provided. The serving node is configured to: cause transmission of wireless device data to the target node for storage in a buffer of the target node; and cause, after transmission of the data, handover of the wireless device to the target node.

According to one or more embodiments of this aspect, the buffer has a buffer size determined according to a machine learning model.

According to one or more embodiments of this aspect, the buffer size is determined based on at least one of: packet loss, packet duplication, or mobility delay.

According to one or more embodiments of this aspect, the serving node is further configured to select the target node from among a plurality of candidate nodes, the plurality of candidate nodes corresponding to a quantity that is based on a Quality-of-Service Class Indicator, QCI, associated with the wireless device.

According to one or more embodiments of this aspect, the serving node is configured to cause the transmission of data to each of the plurality of candidate nodes for storage of the data in a buffer of the respective candidate node.

According to one or more embodiments of this aspect, the target node is selected at least one of: based on a Quality-of-Service Class Indicator, QCI, associated with the wireless device, or according to a machine learning model.

According to one aspect of the present disclosure, a method performed on a serving node configured to communicate with a target node and a wireless device is provided. The method comprises: causing transmission of wireless device data to the target node for storage in a buffer of the target node; and causing, after transmission of the data, handover of the wireless device to the target node.

According to one or more embodiments of this aspect the buffer has a buffer size determined according to a machine learning model.

According to one or more embodiments of this aspect, the buffer size is determined based on at least one of: packet loss, packet duplication, or mobility delay.

According to one or more embodiments of this aspect, the method further comprises selecting the target node from among a plurality of candidate nodes, the plurality of candidate nodes corresponding to a quantity that is based on a Quality-of-Service Class Indicator, QCI, associated with the wireless device.

According to one or more embodiments of this aspect, the method further comprises causing the transmission of data to each of the plurality of candidate nodes for storage of the data in a buffer of the respective candidate node.

According to one or more embodiments of this aspect, the target node is selected at least one of: based on a Quality-of-Service Class Indicator, QCI, associated with the wireless device, or according to a machine learning model.

According to one aspect of the present disclosure, a target node configured to communicate with a serving node and a wireless device is provided. The target node is configured to: receive wireless device data from the wireless device, store the data in a buffer of the target node; and participate, after transmission of the data, in handover of the wireless device to the target node.

According to one or more embodiments of this aspect, the buffer has a buffer size determined according to a machine learning model.

According to one or more embodiments of this aspect, the buffer size is determined based on at least one of: packet loss, packet duplication, or mobility delay.

According to one or more embodiments of this aspect, the target node is a candidate node of a plurality of candidate nodes, the plurality of candidate nodes corresponding to a quantity that is based on a Quality-of-Service Class Indicator, QCI, associated with the wireless device.

According to one aspect of the present disclosure, a method performed in a target node configured to communicate with a serving node and a wireless device is provided. The method comprises: receiving wireless device data from the wireless device, storing the data in a buffer of the target node; and participating, after transmission of the data, in handover of the wireless device to the target node.

According to one or more embodiments of this aspect, the buffer has a buffer size determined according to a machine learning model.

According to one or more embodiments of this aspect, the buffer size is determined based on at least one of: packet loss, packet duplication, or mobility delay.

According to one or more embodiments of this aspect, the target node is a candidate node of a plurality of candidate nodes, the plurality of candidate nodes having a quantity, the quantity being based on a Quality-of-Service Class Indicator, QCI, associated with the wireless device.

According to one aspect of the present disclosure, a wireless device configured to communicate with a target node and a serving node is provided. The serving node comprises processing circuitry configured to: transmit wireless device data to the target node for storage in a buffer of the target node; and participate, after transmission of the data, in handover of the wireless device to the target node.

According to one or more embodiments of this aspect, the buffer has a buffer size determined according to a machine learning model.

According to one or more embodiments of this aspect, the buffer size is determined based on at least one of: packet loss, packet duplication, and mobility delay.

According to one or more embodiments of this aspect, the target node is a candidate node of a plurality of candidate nodes, the plurality of candidate nodes corresponding to a quantity that is based on a Quality-of-Service Class Indicator, QCI, associated with the wireless device.

According to one aspect of the present disclosure, a method performed in a wireless device configured to communicate with a target node and a serving node is provided. The method comprises: transmitting wireless device data to the target node for storage in a buffer of the target node; and participating, after transmission of the data, in handover of the wireless device to the target node.

According to one or more embodiments of this aspect, the buffer has a buffer size determined according to a machine learning model.

According to one or more embodiments of this aspect, the buffer size is determined based on at least one of: packet loss, packet duplication, or mobility delay.

According to one or more embodiments of this aspect, the target node is a candidate node of a plurality of candidate nodes, the plurality of candidate nodes corresponding to a quantity that is based on a Quality-of-Service Class Indicator, QCI, associated with the wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIGS. 1A and 1B form a diagram of an example conditional handover;

FIG. 2 is a schematic diagram of an example of reinforcement learning;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for handover procedures according to some embodiments of the present disclosure; FIG. 10 is a flowchart of an example process in a wireless device according to some embodiments of the present disclosure;

FIG. 11 is a flowchart of an example process in a serving node according to some embodiments of the present disclosure;

FIG. 12 is a flowchart of an example process in a target node according to some embodiments of the present disclosure;

FIG. 13 is a flowchart of an example process in a wireless device according to some embodiments of the present disclosure;

FIG. 14 is a block diagram according to some embodiments of the present disclosure;

FIGS. 15A and 15B form a diagram of an example process for handover procedures according to some embodiments of the present disclosure;

FIG. 16 is a schematic diagram of an example of a management system according to some embodiments of the present disclosure; and

FIGS. 17A and 17B form a diagram of another example process for handover procedures according to some embodiments of the present disclosure.

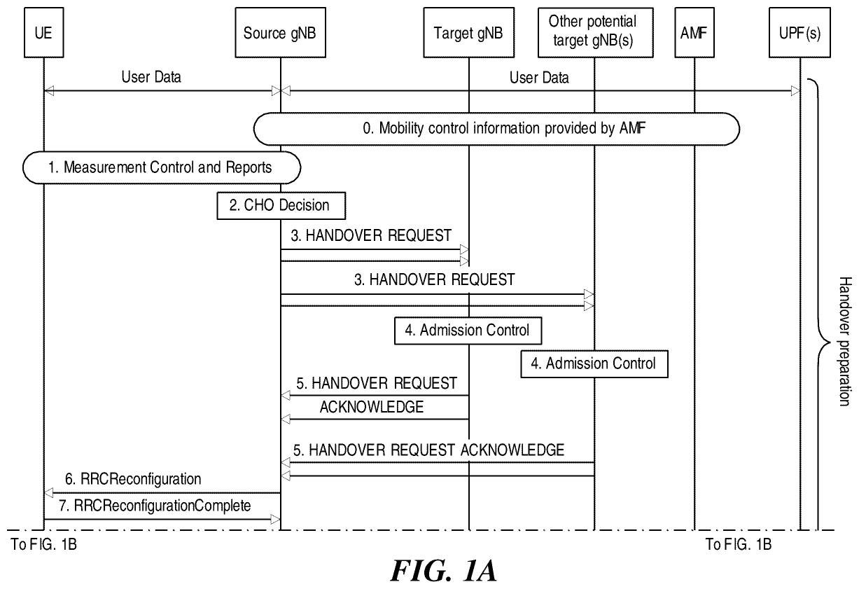

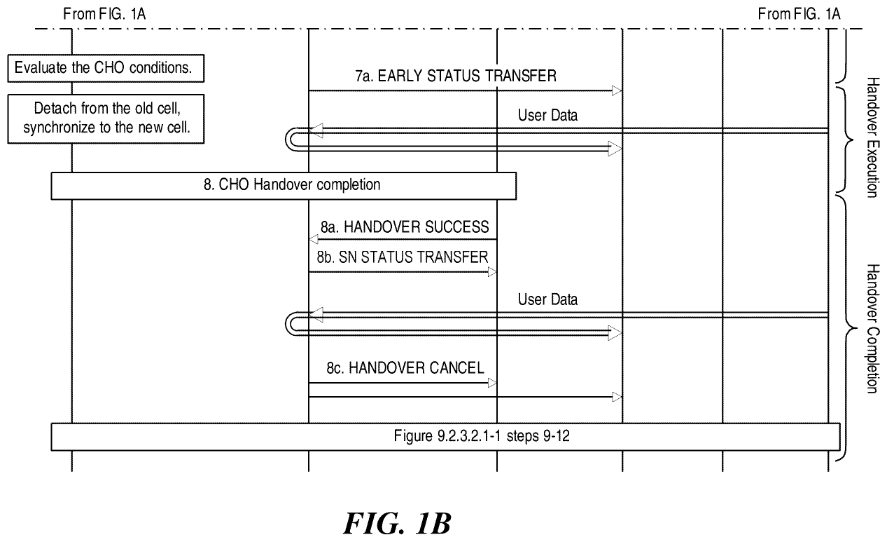

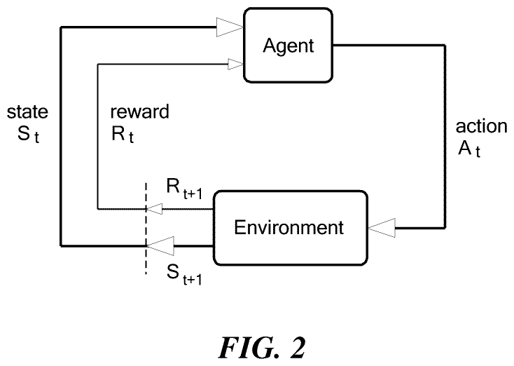

### DETAILED DESCRIPTION

Before describing in detail example embodiments, it is noted that the embodiments reside primarily in combinations of apparatus components and processing steps related to handover procedures. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), target network node (target node), source network node (source node), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

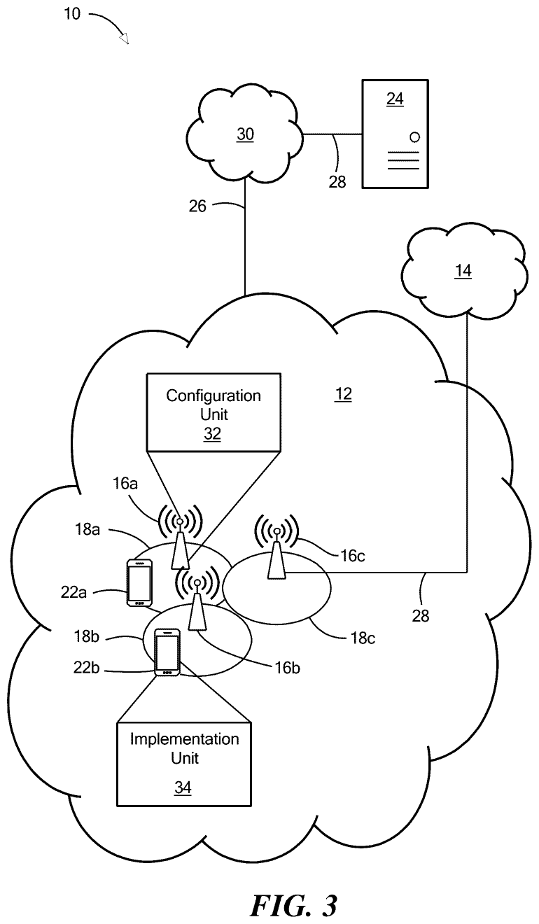

Some embodiments provide for handover procedures. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

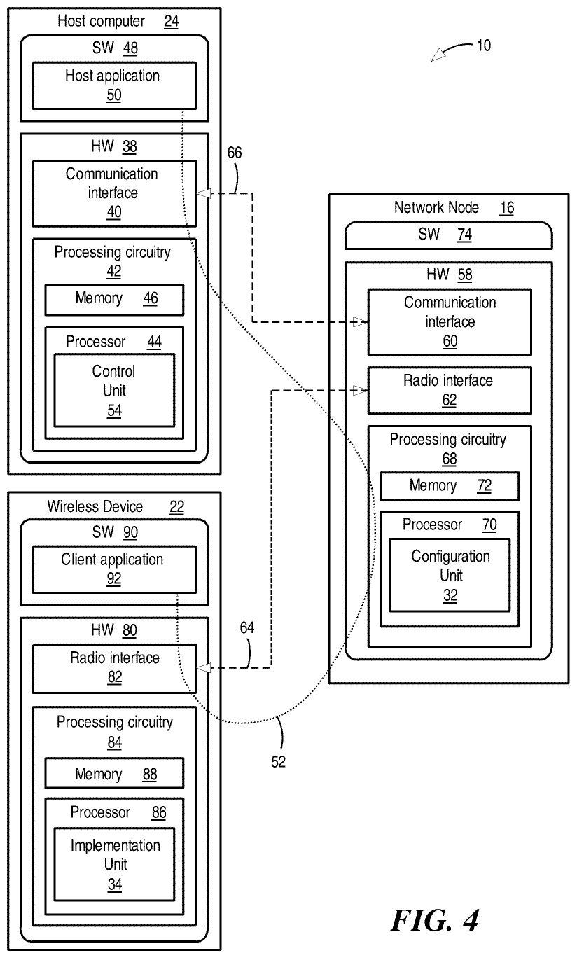

A network node 16 is configured to include a configuration unit 32 which is configured to perform one or more network node 16 functions described herein, including functions related to handover. A wireless device 22 is configured to include an implementation unit 34 which is configured to perform one or more wireless device 22 functions described herein, including functions related to handover. Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to handover.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or more wireless device 22 functions described herein, including functions related to handover.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending to a transmission the network node 16, and/or preparing/terminating/maintaining/supporting/ending in receipt of a transmission from the network node 16.

Although FIGS. 3 and 4 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

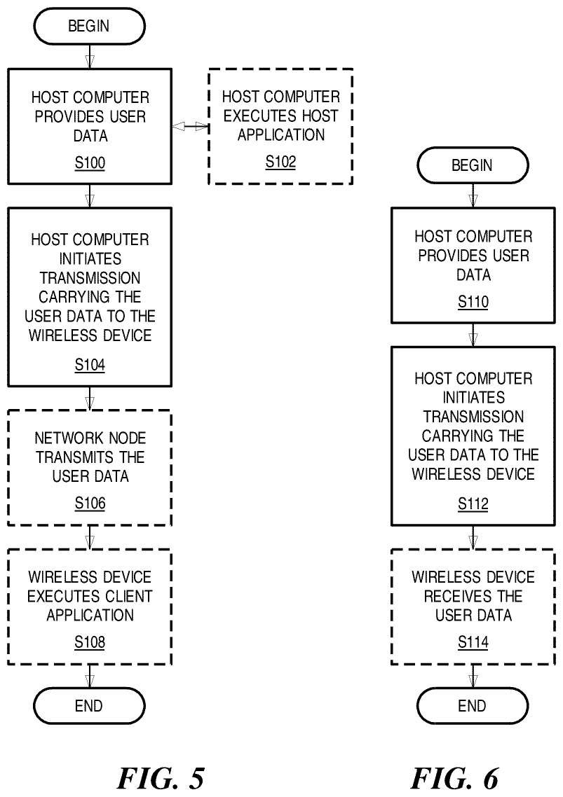

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

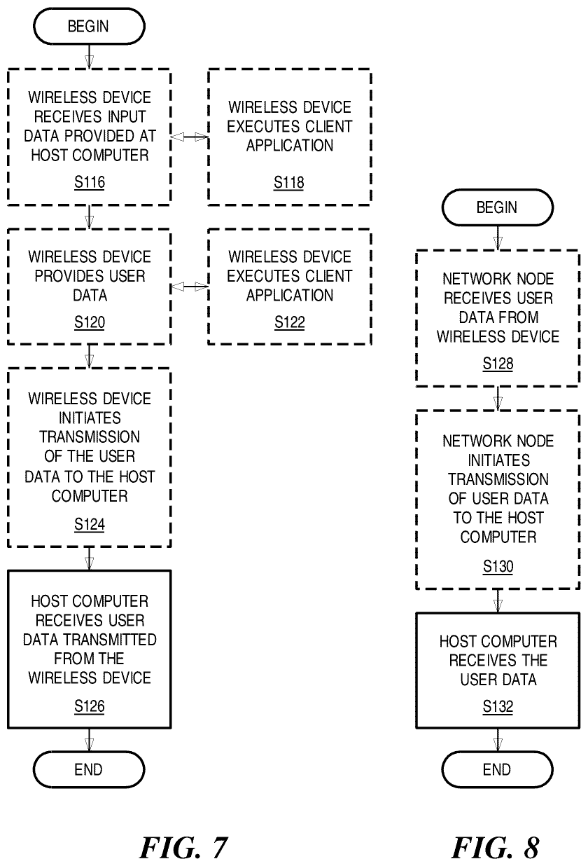

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

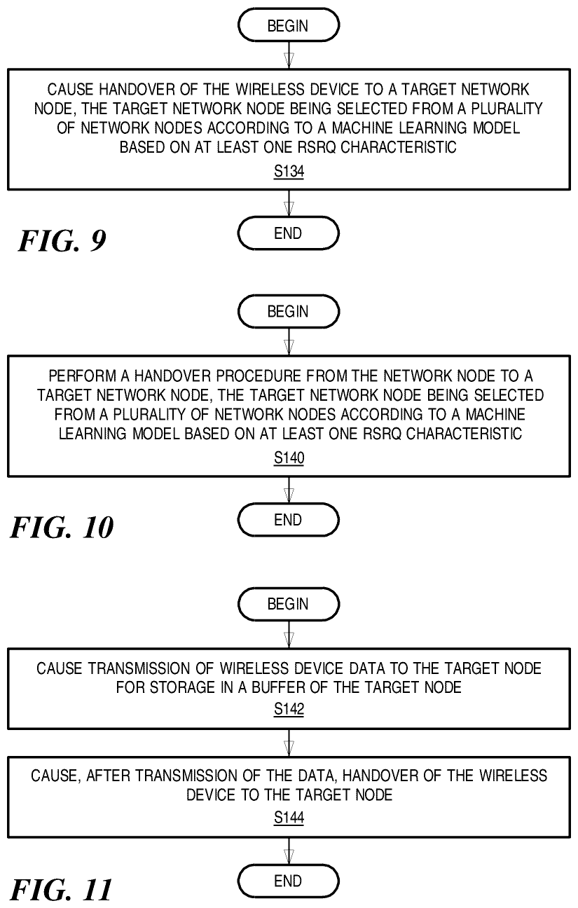

FIG. 9 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to cause handover of the wireless device to a target network node, the target network node being selected from a plurality of network nodes according to a machine learning model based on at least one RSRQ characteristic (Block S134).

In at least one embodiment, the network node is configured to cause transmission of data to the target network node to be stored in a buffer having a buffer size determined according to the machine learning model. In at least one embodiment, the RSRQ characteristic is at least one of a RSRQ value and a RSRQ change rate. According to one or more embodiments, the buffer size may be determined by a serving network node 16, i.e., serving cell or S-BS.

FIG. 10 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to perform a handover procedure from the network node to a target network node, the target network node being selected from a plurality of network nodes according to a machine learning model based on at least one RSRQ characteristic (Block S140).

In at least one embodiment, the processing circuitry is further configured to receive from the target network node buffered data after completion of the handover procedure, the buffered data having a size determined according to the machine learning model. In at least one embodiment, the RSRQ characteristic is at least one of a RSRQ value and a RSRQ change rate.

FIG. 11 is a flowchart of an example process in a network node 16 acting as a serving network node 16 (also referred to as serving node) according to some embodiments of the present disclosure. One or more blocks described herein may be performed by one or more elements of network node 16 such as by one or more of processing circuitry 68 (including the configuration unit 32), processor 70, radio interface 62 and/or communication interface 60. The serving node is configured to: cause transmission of wireless device 22 data to the target node for storage in a buffer of the target node (Block S142). Serving node is configured to cause, after transmission of the data, handover of the wireless device 22 to the target node (Block S144).

In at least one embodiment, the buffer has a buffer size determined according to a machine learning model.

In at least one embodiment, the buffer size is determined based on at least one of: packet loss, packet duplication, or mobility delay.

In at least one embodiment, the serving node is further configured to select the target node from among a plurality of candidate nodes, the plurality of candidate nodes corresponding to a quantity that is based on a Quality-of-Service Class Indicator, QCI, associated with the wireless device 22.

In at least one embodiment, the serving node is configured to cause the transmission of data to each of the plurality of candidate nodes for storage of the data in a buffer of the respective candidate node.

In at least one embodiment, the target node is selected at least one of: based on a Quality-of-Service Class Indicator, QCI, associated with the wireless device 22, or according to a machine learning model.

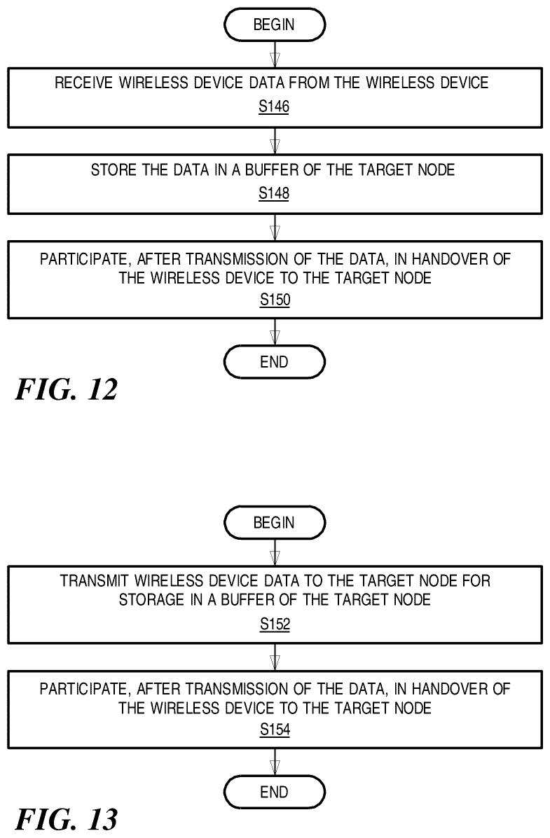

FIG. 12 is a flowchart of an example process in a network node 16 acting as a target network node 16 (also referred to as target node) according to some embodiments of the present disclosure. One or more blocks described herein may be performed by one or more elements of network node 16 such as by one or more of processing circuitry 68 (including the configuration unit 32), processor 70, radio interface 62 and/or communication interface 60. The target node is configured to receive wireless device data from the wireless device 22 (Block S146). Target node is configured to store the data in a buffer of the target node (Block S148). Target node is configured to participate, after transmission of the data, in handover of the wireless device 22 to the target node (Block S150).

In at least one embodiment, the buffer has a buffer size determined according to a machine learning model.

In at least one embodiment, the buffer size is determined based on at least one of: packet loss, packet duplication, or mobility delay.

In at least one embodiment, the target node is a candidate node of a plurality of candidate nodes, the plurality of candidate nodes corresponding to a quantity that is based on a Quality-of-Service Class Indicator, QCI, associated with the wireless device 22.

FIG. 13 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. The wireless device 22 is configured to transmit wireless device data to the target node for storage in a buffer of the target node. (Block S152). Wireless device 22 is configured to participate, after transmission of the data, in handover of the wireless device 22 to the target node (Block S154).

In at least one embodiment, the buffer has a buffer size determined according to a machine learning model.

In at least one embodiment, the buffer size is determined based on at least one of: packet loss, packet duplication, or mobility delay.

In at least one embodiment, the target node is a candidate node of a plurality of candidate nodes, the plurality of candidate nodes corresponding to a quantity that is based on a Quality-of-Service Class Indicator, QCI, associated with the wireless device 22.

Having described the general process flow of arrangements of the disclosure and having provided examples of hardware and software arrangements for implementing the processes and functions of the disclosure, the sections below provide details and examples of arrangements for handover. One or more wireless device 22 functions described below may be performed by one or more of processing circuitry 84, processor 86, implementation unit 34, etc. One or more network node 16 (e.g., serving node, target node, etc.) functions described below may be performed by one or more of processing circuitry 68, processor 70, configuration unit 32, etc. As an initial matter, it is noted that references to cells and serving cells may refer to the network nodes 16 that establish the cell.

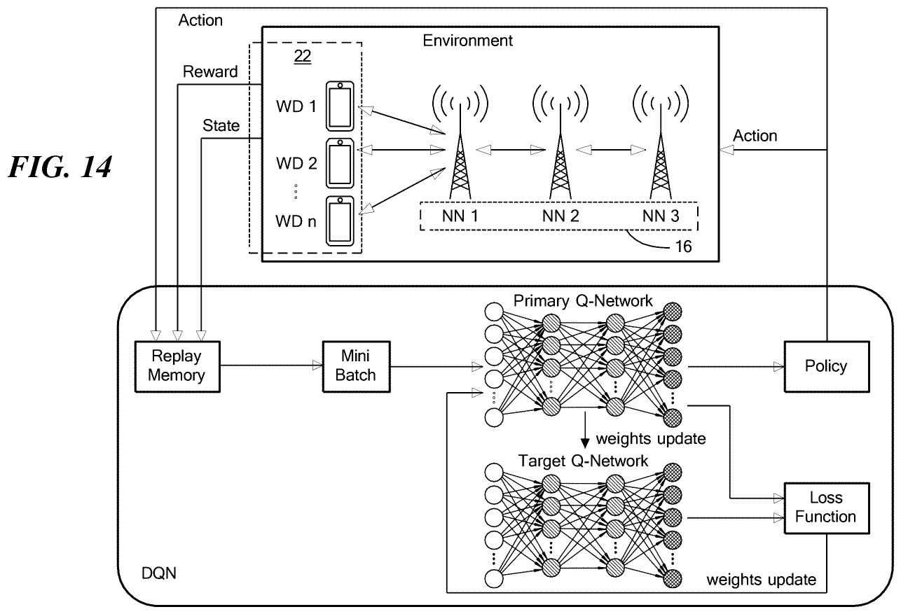

Some embodiments for handover procedures. FIG. 14 depicts a system-level diagram of a PHO methodology and/or management solution in accordance with the present disclosure. Specifically, the independent wireless-device-associated agent is controlled by the deep Q-network (DQN) algorithm. An individual agent learns the optimal policy for target cell selection with the goal of maximizing its own PHO success rate. During a wireless device 22's movement, the pre-connection in PHO can be established by observing the RSRQ conditions and RSRQ change rates of candidate target cell(s). The optimal target cell is selected by a DQN-based wireless device 22-associated agent. PHO is a network-controlled and UE-assisted handover solution.

Aspects of the present disclosure may focus on DQN-based agents. However, some other DRL algorithms can also be adopted to aim for the same goal.

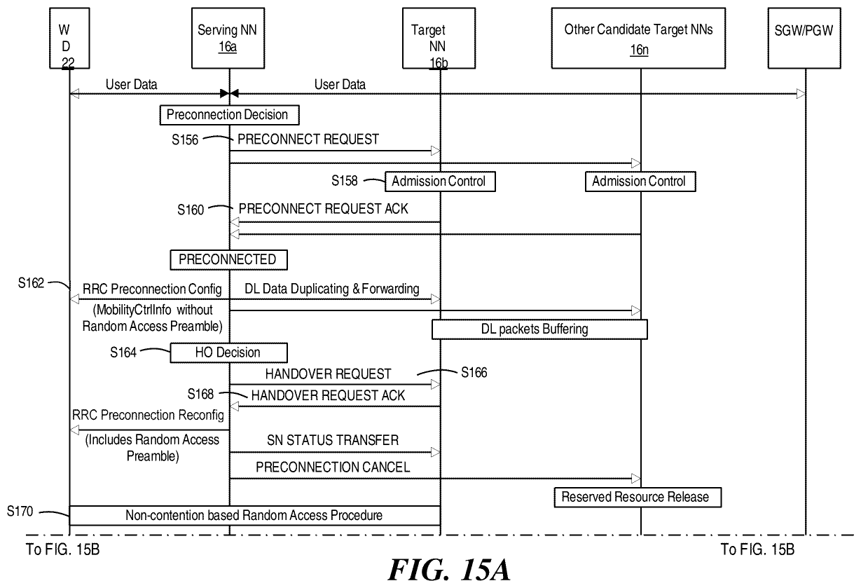

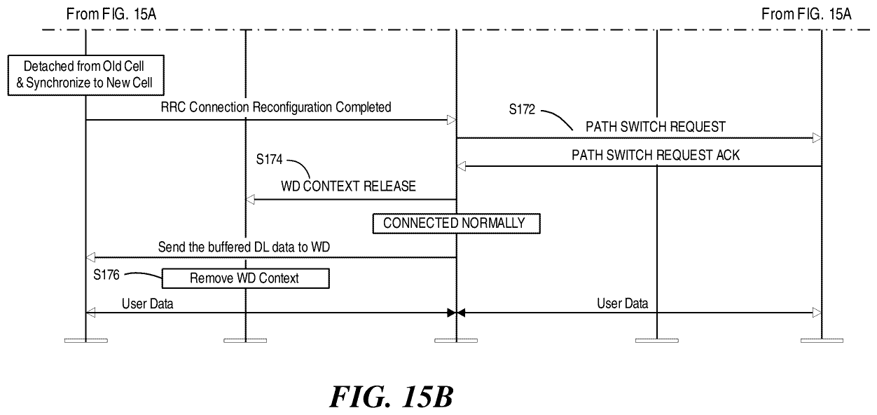

FIGS. 15A and 15B form a diagram of an example embodiment of a PHO procedure. During a wireless device 22's movement, the pre-connection in PHO can be established by observing the RSRQ conditions and RSRQ change rates of candidate target network nodes 16, i.e., target cell/base stations (T-BSs). The optimal target network node 16b (T-BS) is selected by a DQN-based wireless-device-associated agent. PHO is a network-controlled and wireless-device-assisted handover solution. An embodiment is depicted in FIGS. 14 and 15A-15B and further explained as follows.

The serving network node 16a, i.e., serving cell/base station (S-BS) initiates the process by sending a Preconnect Request message to one or more network node 16s, i.e., T-BSs/target cell 16b and 16n, through the X2 interface (Block S156).

Upon receiving the Preconnect Request message from network node 16a, i.e., S-BS or serving cell, network nodes 16b and 16n, i.e., T-BS or target cell, can either accept or reject the request under its own admission control. If the request is accepted (Block S158), the network nodes 16b and 16n, T-BS or target cell, prepare a handover command, and send it within the Preconnect Request Acknowledge message to network node 16a, i.e., S-BS or serving cell, via the X2 interface (Block S160).

Once receiving the Preconnect Request Acknowledge message from network nodes 16b and 16n, i.e., T-BS or target cell, the network node 16a, i.e., S-BS or serving cell, sends the handover command to wireless device 22 through the Radio Resource Control (RRC) Preconnection Configuration message and switches the state to PRECONNECTED. After that, the network node 16a, i.e., S-BS or serving cell, starts the early downlink (DL) forwarding process to the pre-connected network nodes 16b and 16c, i.e., T-BS or target cell. The received DL packets are buffered in a capacity-adjustable queue at network nodes 16b and 16n, i.e., T-BS or target cell. The queue capacity is defined as the number of PDCP SDUs (Block S162).

The wireless device 22 receives RRC Preconnection Configuration message and switches the state to PRECONNECTED, which indicates the pre-connection is established successfully. The wireless device 22 holds the received handover command without taking any action (Also Block S162).

When the trigger condition of the handover event is satisfied, the handover is triggered (Block S164). Then, the network node 16a, i.e., S-BS or serving cell, sends a Preconnect Handover Request message to the pre-connected network node 16b, i.e., T-BS or target cell (Block S166).

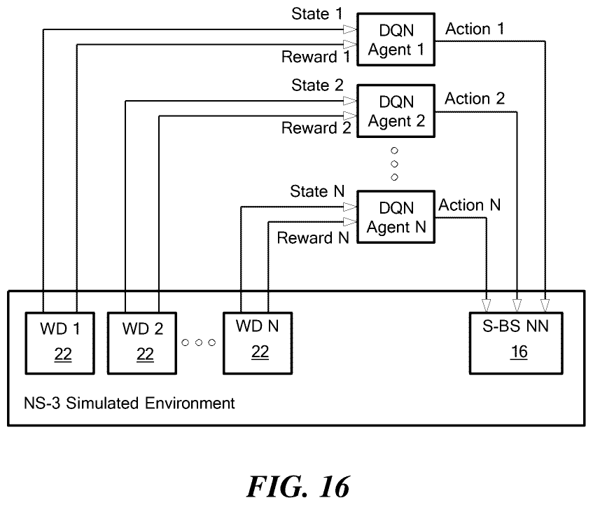

Upon receiving the Preconnect Handover Request message from the network node 16a, i.e., S-BS or serving cell, the network node 16b, i.e., T-BS or target cell, checks the availability of the pre-allocated resources for the wireless device 22. If the resources are still available, the network node 16b, i.e., T-BS or target cell, will allocate the random-access preamble identifier (RAPID), which is used by a wireless device 22 to access the network node 16a on the random-access channel. Network node 16b, i.e., T-BS or target cell, then sends a Preconnect Handover Request Acknowledge message to S-BS or serving cell to accept the request (Block S168). In some embodiments, the selection of the particular network node 16b, T-BS or target cell, is based on an ML process such as by a DQN-based wireless-device-associated agent (as illustrated in FIG. 16).

The network node 16a, i.e., S-BS or serving cell, receives the Preconnect Handover Request Acknowledge message, then sends an RRC Connection Reconfiguration message to wireless device 22 to modify an RRC connection of resource blocks to perform the handover. The network node 16a, i.e., S-BS or serving cell, also sends the Sequence Number (SN) Status Transfer message to the network node 16b, i.e., T-BS or target cell, through the X2 interface to convey the uplink PDCP SN receiver status and the downlink PDCP SN transmitter status of the Radio Access Bearer. In addition, if multiple pre-connections have been established with other candidate network nodes 16n, i.e., T-BSs or target cell, then network node 16a, i.e., S-BS or serving cell, sends a Pre-connection Cancel message to notify all the other candidate T-BSs or target cells to release the reserved resources (also Block S168).

After receiving the RRC Connection Reconfiguration message from network node 16a, i.e., S-BS or serving cell, the wireless device 22 extracts the RAPID, starts the random-access procedure with network node 16b, i.e., T-BS or target cell. If the random-access procedure is completed successfully, the wireless device 22 sends an RRC Connection Reconfiguration Complete message to network node 16b, i.e., T-BS or target cell, to notify of the success, and switches the state to PRECONNECT_NORMALLY. The successful outcome indicates the handover completion in radio access networks (RAN) (Block S170).

Upon receiving the RRC Connection Reconfiguration Complete message from the wireless device 22, network node 16b, i.e., T-BS or target cell, sends a Path Switch Request message through the S1 interface to inform the MME that the wireless device 22 has switched the connection to T-BS or target cell, and to request the path switch on the core network (CN) (Block S172).

Network node 16b, i.e., T-BS or target cell, receives the Path Switch Request Acknowledge message, which means the data plane has been switched to T-BS or target cell by the CN. The network node 16b, i.e., T-BS or target cell, starts sending the buffered downlink PDCP SDUs to the wireless device 22, and also informs the successful handover to the network node 16a, i.e., S-BS or serving cell, by sending the wireless device Context Release message (Block S174).

Finally, upon receiving the wireless device Context Release message, the network node 16a, i.e., S-BS or serving cell, releases the radio and control plane resources associated with the wireless device 22 (Block S176).

The following table depicts signals that may be used in at least one embodiment. These signals/messages are not present in existing specifications, such as those propagated by, e.g., 3GPP.

| | Signal Direction | |
|---|---|---|
| | Serving Cell | |
| | (S-Cell); | |
| | Target Cell | |
| Name | (T-Cell) | Type |
| Pre-connect | S-Cell −> All | New |
| Request | the candidate | The message information |
| Message | T-Cells | includes at least the target cell |
| | | ID, the C-RNTI of the UE in |
| | | the source gNB, RRM- |
| | | configuration including UE |
| | | inactive time, the current |
| | | QCI level, the buffer size to |
| | | use for packet buffering, the |
| | | UE capabilities for different |
| | | RATs, QoS flow level QoS |
| | | profile(s) |
| | | After issuing a Pre-connect |
| | | Handover Request, the source |
| | | gNB should not reconfigure |
| | | the UE, |
| Pre-connect | T-Cell −> S-Cell | New |
| Request ACK | | The message information |
| Message | | includes at least the target cell |
| | | ID, radio resource |
| | | availability. |
| RRC Pre-connection | S-Cell −> UE | New |
| Configuration | | The message contain the |
| Message | | information required to access |
| | | the target cell. At least the |
| | | target cell ID, the new C- |
| | | RNTI, It can also include a set |
| | | of dedicated RACH |
| | | resources, and system |
| | | information of the target cell, |
| | | etc. But No random access |
| | | preamble info included. |
| Pre-connect | S-Cell −> T-Cell | Modified from |
| Handover Request | | 3GPP Handover Request |
| Message | | Message. |
| | | The message is only sent to |
| | | the pre-connected target cell. |
| | | It can include the entire or |
| | | part of Pre-connect Request |
| | | Message. |
| Handover Request | T-Cell −> S-Cell | 3GPP |
| ACK Message | | |
| RRC Configuration | S-Cell −> UE | 3GPP |
| Reconfiguration | | |
| Message | | |
| SN Status Transfer | S-Cell −> T-Cell | 3GPP |
| Pre-connection | S-Cell −> | New |
| Cancellation | All other T-Cells | If there are more than one pre- |
| Message | | connected target cells, The |
| | | this message will be |
| | | initialized, and sent to all |
| | | other T-Cells to cancel the |
| | | pre-connection. The message |
| | | information includes at least |
| | | the target cell ID, the C-RNTI |
| | | of the UE in the source gNB. |
| | | When the target cell receives |
| | | the message, all the pre- |
| | | allocated radio resources will |
| | | be released; all the pre- |
| | | buffered data will be |
| | | discarded. |
| Random Access | UE <−> T-Cell | 3GPP |
| Procedure | | |
| RRC Connection | UE <−> T-Cell | 3GPP |
| Reconfiguration | | |
| Completed Message | | |
| Path Switch Request | T-Cell −> | 3GPP |
| Message | MME/SGW | |
| Path Switch Request | MME/SGW −> | 3GPP |
| ACK Message | T-Cell | |

An example embodiment of a multi-agent DQN-assisted PHO management solution for optimal target cell, i.e., network node 16b, selection is shown in FIG. 16. Each independent wireless-device-associated agent is controlled by the DQN algorithm, and the local reward strategy provides different reward values as the feedback to the agent. An individual agent learns the optimal policy for network node 16b, i.e., T-BS or target cell, selection with the goal of maximizing its own PHO success rate.

In addition, various embodiments in accordance with the present disclosure, including offline training and online prediction framework, can potentially be set up with open radio access network (ORAN), as described below:
The RSRQ values are collected from real networks and transmitted to the Non-Real Time RAN Intelligent Controller (RIC) via the O1 interface. The RSRQs are used as one of the input features of the DQN.
Offline training: The UE-associated DQN agent or MADRL-based agents can be set up on Non-Real Time RIC for offline model training. The trained model can be updated dynamically based on the network conditions.
Online prediction in a real-time application: The trained model can be transmitted to a Near-Real Time RIC via A1 interface. The online prediction is conducted on a Near-Real Time RIC by using the trained model.

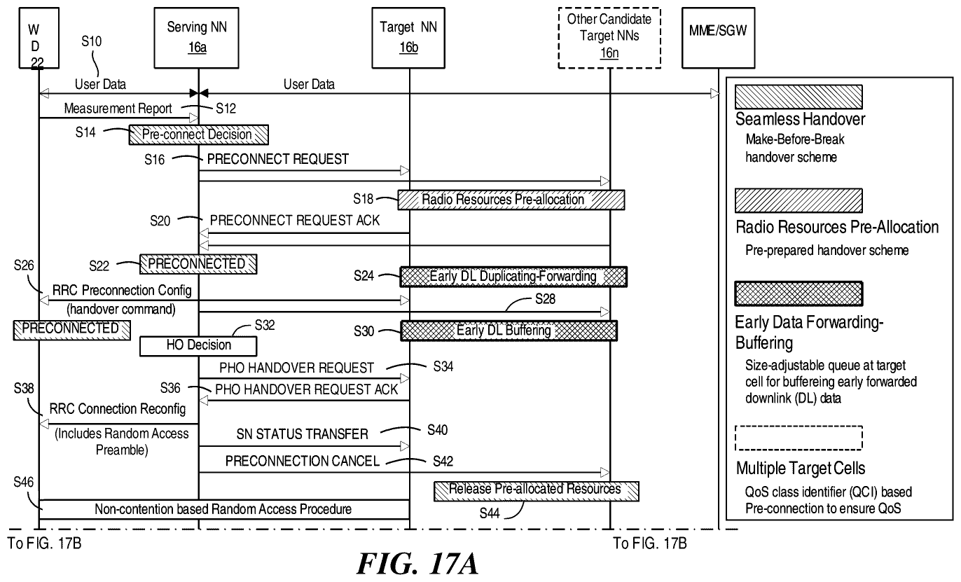

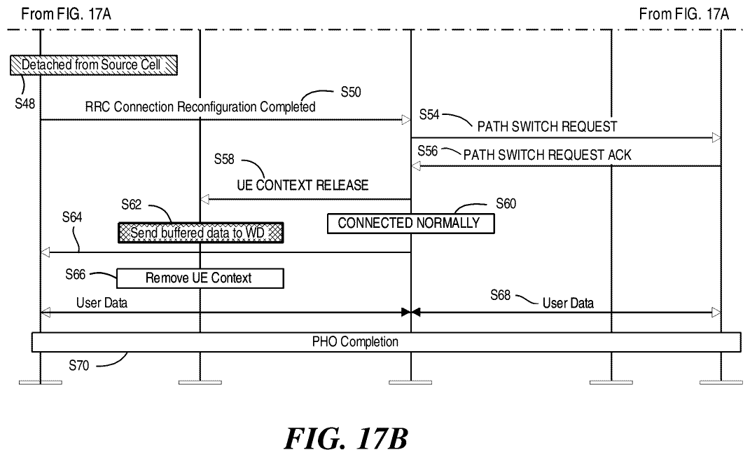

FIGS. 17A and 17B form a diagram of an example embodiment of a PHO procedure. A wireless device 22 exchanges user data with a serving network node 16a, which exchanges data with a MME/serving gateway (SGW) (Block S10). The wireless device 22 sends a measurement report to the serving network node 16a (Block S12). The serving network node 16a makes a pre-connection decision (Block S14). The serving network node 16a sends a preconnect request to a target network node 16b and/or other target network nodes 16n (Block S16). The target network node 16b and/or other target network nodes 16n pre-allocate radio resources (Block S18). The target network node 16b and/or other target network nodes 16n send a pre-connect request acknowledgement to the serving network node 16a (Block S20). The serving network node 16a determines a preconnected status (Block S22). The target network node 16b and/or other target network nodes 16n perform early DL duplicating-forwarding (Block S24). The wireless device 22 and target network node 16a exchange a RRC pre-connection configuration (handover command) (Block S26). The serving network node 16a sends a signal to the other target network nodes 16n (Block S28). The target network node 16b and/or other target network nodes 16n perform early DL buffering (Block S30). The serving network node 16a performs a HO decision (Block S32). The serving network node 16a sends a PHO handover request to the target network node 16b (Block S34), and the target network node 16b responds by sending an acknowledgement (Block S36). The serving network node 16a sends an RRC connection reconfiguration (including random access preamble) to the wireless device 22 (Block S38). The serving network node 16a sends a SN status transfer to the target network node 16b (Block S40) and sends a pre-connection cancel message to the other target network nodes 16n (Block S42). The target network node 16b and/or other target network nodes 16n release pre-allocated resources (Block S44). The wireless device 22, serving network node 16a, and target network node 16b perform a non-contention based random access procedure (Block S46). The wireless device 22 is detached from the serving network node 16a (Block S48). The wireless device 22 sends a RRC connection reconfiguration completed message to the target network node 16b (Block S50). The wireless device 22 is connected normally (Block S52). The target network node 16a sends a path switch request to the MME/SGW (Block S54), which sends a path switch request acknowledgement (Block S56). The target network node 16a sends a UE context release to release the wireless device 22 context (Block S58). The target network node 16a is connected normally (Block S60). The target network node 16b sends (Block S62) and the wireless device 22 receives (Block S64) buffered DL data. The target serving network node 16a removes the UE context (e.g., the wireless device 22 context) (Block S66). User data is exchanged between the wireless device 22 and target network node 16a, and between the target network node 16a and the MME/SGW (Block S68). The PHO is completed (Block S70).

### Some Examples:

Example A1. A network node configured to communicate with a wireless device (WD), the network node configured to, and/or comprising a radio interface and/or comprising processing circuitry configured to:
cause handover of the wireless device to a target network node, the target network node being selected from a plurality of network nodes according to a machine learning model based on at least one RSRQ characteristic.

Example A2. The network node of Example A1, wherein the network node is configured to cause transmission of data to the target network node to be stored in a buffer having a buffer size determined according to the machine learning model.

Example A3. The network node of Example A1, wherein the RSRQ characteristic is at least one of a RSRQ value and a RSRQ change rate.

Example B1. A method implemented in a network node, the method comprising:
causing handover of the wireless device to a target network node, the target network node being selected from a plurality of network nodes according to a machine learning model based on at least one RSRQ characteristic.

Example B2. The method of Example B1, wherein the network node is configured to cause transmission of data to the target network node to be stored in a buffer having a buffer size determined according to the machine learning model.

Example B3. The method of Example B1, wherein the RSRQ characteristic is at least one of a RSRQ value and a RSRQ change rate.

Example C1. A wireless device (WD) configured to communicate with a first network node, the WD configured to, and/or comprising a radio interface and/or processing circuitry configured to:
perform a handover procedure from the network node to a target network node, the target network node being selected from a plurality of network nodes according to a machine learning model based on at least one RSRQ characteristic.

Example C2. The WD of Example C1, the processing circuitry being further configured to receive from the target network node buffered data after completion of the handover procedure, the buffered data having a size determined according to the machine learning model.

Example C3. The WD of Example C1, wherein the RSRQ characteristic is at least one of a RSRQ value and a RSRQ change rate.

Example D1. A method implemented in a wireless device (WD), the method comprising:
performing a handover procedure from the network node to a target network node, the target network node being selected from a plurality of network nodes according to a machine learning model based on at least one RSRQ characteristic.

Example D2. The method of Example D1, further comprising receiving from the target network node buffered data after completion of the handover procedure, the buffered data having a size determined according to the machine learning model.

Example D3. The method of Example D1, wherein the RSRQ characteristic is at least one of a RSRQ value and a RSRQ change rate.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

3GPP Third Generation Partnership Project
5G Fifth Generation
BS Base Station
CHO Conditional Hanover
CN Core Network
DNN Deep Neural Network
DQN Deep Q-Network
DRL Deep Reinforcement Learning
HIT Handover Interruption Time
IMSI International Mobile Subscriber Identity
LTE Long Term Evolution
MADRL Multi-Agent Deep Reinforcement Learning
MBB Make-Before-Break
MIT Mobility Interruption Time
ML Machine Learning
MR Measurement Report
PDCP Packet Data Convergence Protocol
PHO Pre-connect Handover
QCI Quality of Service Class Indicator
QoS Quality of Service
RAPID Random-Access Preamble Identifier
RIC RAN Intelligent Controller
RL Reinforcement Learning
RNTI Radio Network Temporary Identifier
RRC Radio Resource Control
RSRQ Reference Signal Received Quality
SDU Service Data Units
SN Sequence Number
S-BS Serving Base Station
T-BS Target Base Station
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-6. (canceled)

7. A method performed on a serving node configured to communicate with a target node and a wireless device, the method comprising:
causing transmission of wireless device data to the target node for storage in a buffer of the target node, wherein the buffer has a buffer size determined according to a machine learning model; and
causing, after transmission of the data, handover of the wireless device to the target node.

8. (canceled)

9. The method of claim 7, wherein the buffer size is determined based on packet loss.

10. The method of claim 7, further comprising selecting the target node from among a plurality of candidate nodes, the plurality of candidate nodes corresponding to a quantity that is based on a Quality-of-Service Class Indicator, QCI, associated with the wireless device.

11. The method of claim 10, further comprising causing the transmission of data to each of the plurality of candidate nodes for storage of the data in a buffer of the respective candidate node.

12. The method of claim 10, wherein the target node is selected based on a Quality-of-Service Class Indicator, QCI, associated with the wireless device.

13-16. (canceled)

17. A method performed in a target node configured to communicate with a serving node and a wireless device, method comprising:
receiving wireless device data from the wireless device;
storing the data in a buffer of the target node, wherein the buffer has a buffer size determined according to a machine learning model; and
participating, after transmission of the data, in handover of the wireless device to the target node.

18. (canceled)

19. The method of claim 17, wherein the buffer size is determined based on packet loss.

20. The method of claim 17, wherein the target node is a candidate node of a plurality of candidate nodes, the plurality of candidate nodes corresponding to a quantity that is based on a Quality-of-Service Class Indicator, QCI, associated with the wireless device (22).

21. A wireless device (22) configured to communicate with a target node and a serving node, the serving node comprising processing circuitry configured to:
transmit wireless device data to the target node for storage in a buffer of the target node, wherein the buffer has a buffer size determined according to a machine learning model; and
participate, after transmission of the data, in handover of the wireless device to the target node.

22. (canceled)

23. The wireless device of claim 21, wherein the buffer size is determined based on packet loss.

24. The wireless device of claim 21, wherein the target node is a candidate node of a plurality of candidate nodes, the plurality of candidate nodes corresponding to a quantity that is based on a Quality-of-Service Class Indicator, QCI, associated with the wireless device.

25-28. (canceled)

29. The method of claim 7, wherein the buffer size is determined based on packet duplication.

30. The method of claim 7, wherein the buffer size is determined based on mobility delay.

31. The method of claim 10, wherein the target node is selected according to a machine learning model.

32. The method of claim 17, wherein the buffer size is determined based on packet duplication.

33. The method of claim 17, wherein the buffer size is determined based on mobility delay.

34. The method of claim 21, wherein the buffer size is determined based on packet duplication.

35. The method of claim 21, wherein the buffer size is determined based on mobility delay.
